(19) United States
(12) Patent Application Publication
(10) Pub. No.: US 2026/0148655 A1
(43) Pub. Date: May 28, 2026

(54) APPARATUSES, METHODS, AND SYSTEMS FOR GENERATING VIRTUALIZATIONS INCLUDING FOR TRAINING EXERCISES

(71) Applicant: Booz Allen Hamilton Inc., McLean, VA (US)

(72) Inventor: Michael S. Sullivan, Valparaiso, FL (US)

(73) Assignee: Booz Allen Hamilton Inc., McLean, VA (US)

(21) Appl. No.: 19/402,625

(22) Filed: Nov. 26, 2025

Related U.S. Application Data
(60) Provisional application No. 63/726,035, filed on Nov. 27, 2024.

(51) Int. Cl. G09B 9/00; G09B 5/02

(52) U.S. Cl. CPC G09B 9/003; G09B 5/02

(57) ABSTRACT

Systems and methods include a physical platform having a camera that generates a live video feed from a point of view of the physical platform in a training location. A computing system of the physical platform detects one or more live assets in the live video feed and injects synthetic data into the live video feed based on the one or more detected live assets. Synthesized data for each live asset is generated by combining an operator interface associated with the physical platform and the live video feed including the one or more detected live assets and the synthetic data. The computing system overlays the operator interface onto the live video feed and controls the synthetic data to move in a specified alignment relative to the one or more detected live assets. The synthesized data is displayed on a graphical interface of a display device.

### RELATED APPLICATION

This application claims priority to U.S. Application No. 63/726,035 filed on November 27, 2024, the entire content of which is hereby incorporated by reference.

### FIELD

The present disclosure relates to apparatuses, systems, and methods for technological advancement of situational awareness including, in non-limiting examples, generating virtualized representations of an environment via a physical platform.

### BACKGROUND

Detection of threats is paramount in everyday life whether walking down the street on engaged in military combat. Understanding your surroundings, including people, objects, context, etc., is extremely challenging from a technical standpoint, even more so in the context of developing virtualizations including simulated training. Often, there is a disconnect between understanding physical surroundings and developing realistic virtualized training, as well as extending simulated training scenarios. Traditionally, equipment and processing methods struggle with these aspects in addition to being inefficient from device and processing perspectives, and further lacking portability and form factorization (e.g., traditional training sims require tremendous technical resources and numerous personnel). Further issues persist in contextual understanding and integrating with emerging technology including artificial intelligence (AI).

### SUMMARY

Non-limiting examples described herein describe generation and management of virtualized representation of an environment via an exemplary physical platform. For ease of explanation, an example of virtualization that is referenced may be a virtual training exercise, however any technology in the present disclosure is also usable in non-training scenarios.

An exemplary method for generating a virtual training exercise on a physical platform is disclosed, the method comprising: generating, by a camera of the physical platform, a live video feed from a point of view of the physical platform in a training location; detecting, by a computing system of the physical platform, one or more live assets in the live video feed; injecting, by the computing system of the physical platform, synthetic data for each of the one or more detected live assets into the live video feed; generating, by the computing device of the physical platform, synthesized data by combining an operator interface associated with the physical platform and the live video feed including the one or more detected live assets and the synthetic data for each of the one or more detected live assets, wherein the operator interface is overlayed onto the live video feed and the synthetic data for each of the one or more detected live assets is controlled to move in a specified alignment relative to the one or more detected live assets; and generating, by a display device of the physical platform, a graphical interface for displaying the synthesized data.

A system for generating a virtual training exercise on a physical platform is disclosed, the system comprising: a camera system mounted to the physical platform, wherein the camera system is configured to generate a live video feed from a point of view of the physical platform in a training location; and a computing system of the physical platform, the computing system being configured to: detect at least one live asset in the live video feed; inject, synthetic data for each of the at least one live asset into the live video feed based on the at least one detected live asset; and generate synthesized data for each of the at least one live asset by combining an operator interface associated with the physical platform, the live video feed including the at least one detected live asset and the synthetic data for each of the at least one live asset, wherein the operator interface is overlayed onto the live video feed and the synthetic data for each of the at least one live asset is controlled to move in a specified alignment relative to the at least one detected live asset; and a display device configured to generate a graphical interface for displaying the synthesized data.

A non-transitory computer-readable medium storing programming code for generating a virtual training exercise on a physical platform is disclosed, which when placed in communicable contact with one or more processors of a physical platform, the computer-readable medium, via the programming code, causing the physical platform to be configured to perform operations comprising: generating, by a camera of the physical platform, a live video feed from a point of view of the physical platform in a training location; detecting, by a computing system of the physical platform, one or more live assets in the live video feed; injecting, by the computing system of the physical platform, synthetic data for each of the one or more detected live assets into the live video feed; generating, by the computing device of the physical platform, synthesized data for each of the one or more detected live assets by combining an operator interface associated with the physical platform and the live video feed including the one or more detected live assets and the synthetic data for each of the one or more detected live assets, wherein the operator interface is overlayed onto the live video feed and the synthetic data is controlled to move in a specified alignment relative to the one or more detected live assets; and generating, by a display device of the physical platform, a graphical interface for displaying the synthesized data.

### DESCRIPTION OF THE DRAWINGS

The scope of the present disclosure is best understood from the following detailed description of exemplary embodiments when read in conjunction with the accompanying drawings. Included in the drawings are the following figures:

FIG. 1 illustrates a system for generating a virtual training exercise on a physical platform in accordance with an exemplary embodiment of the present disclosure.

FIG. 2 illustrates an arrangement of the system in a battlespace according to an exemplary embodiment of the present disclosure.

FIG. 3 illustrates a physical platform in accordance with an exemplary embodiment of the present disclosure.

FIG. 4 illustrates a method for generating a virtual training exercise on a physical platform in accordance with an exemplary embodiment of the present disclosure.

FIGS. 5A and 5B illustrate a deep learning neural network in accordance with an exemplary embodiment of the present disclosure.

FIG. 6 illustrates a hardware configuration of a computing device in accordance with an exemplary embodiment of the present disclosure.

Further areas of applicability of the present disclosure will become apparent from the detailed description provided hereinafter. The detailed descriptions of exemplary embodiments are intended for illustration purposes only and are, therefore, not intended to necessarily limit the scope of the disclosure.

### DETAILED DESCRIPTION

Non-limiting examples of the present disclosure describe apparatuses/devices, systems and methods for technological advancement of situational awareness, including threat detection, that are usable for real-world identification of threat detection and/or adapted simulation, for example, to generate improved virtualization (e.g., augmented reality (AR), virtual reality (VR)) of an environment representative of exemplary physical platforms, virtualize/simulated forms, computer-generated/synthetic forms, or a combination of any thereof. One non-limiting example of virtualization that is described herein for ease of understanding is virtualized training, where virtualized training exercises may be generated for an environment creating multi-dimensional representations of an environment including adapted Live-Virtual-Constructive (LVC) feeds.

As a non-limiting example, a MAN Portable Air Defense Systems (MANPADS) device is disclosed that has been developed and adapted to optimize asset identification, threat detection, and virtualization in an extensible manner, where such devices enable real-world action or virtualized training in a portable, form-factor representation that is further integrateable and extensible with emerging technology including simulation, AI, machine learning (ML), quantum computing/hybrid quantum solutions (e.g., those that can aid simulation). However, exemplary physical platforms are not limited to any form or factor and may comprise anything from wearable devices, vehicles (e.g., planes, cars, tanks, boats. spaceships), combat technology (including weapons in varying forms and aerial devices), and mountable devices, among other non-limiting examples. In at least one example, one or more individual components (e.g., optical camera, AR/VR tech, display, sensors) of an exemplary MANPADS device described herein may be integrated in or attached to other apparatuses/devices to enable adapted, and immersive virtual simulation (e.g., virtual training exercises) to be generated, visualized, and conducted, including remotely.

Moreover, the present disclosure describes novel, adapted virtualization that aggregates data feeds representing real-world live feeds, virtual and synthetic data, combined with dynamic management of contextual data in real-time (or near real-time). The present disclosure generates, renders, executes, and manages an adapted simulated environment (e.g., AR or VR), for example, a live, virtual, constructive (LVC) environment comprising individually one or more from live feeds, virtual feeds, synthetic/constructive feeds, or an aggregated combination of any of the foregoing thereof.

An exemplary simulated environment of the present disclosure is further adapted to be enhanced and continuously optimized via integration and interfacing with a plurality of additional software integrations, AI/ML modeling, etc., as described herein, including to enable bi-directional, adaptable, ad-hoc and secure communications which further contribute to generating specialized computing instances for management of exemplary virtualizations. In an aggregated example, an exemplary environmental virtualization enables engagement of multiple LVC targets simultaneously within a rendered environment. As non-limiting examples, a live feed may be generated and rendered in the environment that is representative of live action or live training (e.g., including interaction of one or more exemplary physical platforms, live data objects, with an environment), whereas a virtual feed may be generated from an interaction with a simulated system (e.g., high-fidelity flight simulator), and a constructive feed may comprise computer-generated or synthetic representations of objects (e.g., computer-generated forces, automated simulations). In this way, virtualized representations are generated, rendered, and displayed in the form of multi-dimensional environments that include feed representations from a variety of sources including those located in one or more disparate locations. For instance, virtual training representations may be a combination of one or more live object feeds (e.g., from a specific physical platform such as a MANPADS device), synthetic feeds (including synthetic object feeds), or a combination of any thereof. This aggregation of feeds created a novel and adapted virtual representation that further can be tailored for practical applications including virtual training exercises.

As highlighted, virtualized representations can be customized and adapted by integrating with additional data sources, resources including software programs, modules, AI/ML modeling, etc., including proprietary or third-party data sources. In this way, virtualization (e.g., an LVC simulated environment) is optimized for realism, extending beyond what is traditionally known while also providing a platform to continuously expand upon. For example, one or more software programs or modules may be integrated and executed to manage and replicate aspects that include but are not limited to: cameras/visual image processing (e.g., optical, thermal, infrared); sensor management and behavior replication (e.g., via sensor input layer and event modeling) including signal detection and processing for any types of sensors such as trigger sensors (e.g., pressure, optical, capacitive), positional sensors, inertial sensors environmental sensors, etc.; object definition libraries and data libraries for management of data, metadata and correlations to more accurately represent components, accessories (e.g., bullets, projectiles, defense mechanisms), behaviors (e.g., components or accessories, projectiles), condition modeling (e.g., dynamic condition modeling), AI enhancement (enhancement and interference management); animation, feedback (haptics and/or user); physics engine simulation; and event interpretation modeling, among other examples.

In further non-limiting examples, AI/ML modeling may be created, trained, and adapted to enhance real-time (or near real-time) virtualization. This can be extremely useful in the context of a live action instance or virtualized training exercise. For example, AI/ML modeling can be leveraged to generate contextual data insights, alterations, notifications, suggestions, recommendations, etc., that can be rendered in or output with a virtualized representation. As an example, data insights, alterations, notifications, suggestions, recommendations, etc., all may be generated based on real-time processing occurring with one or more physical platforms and interactions within an exemplary environment. In addition, such examples may also be generated based on historical processing that correlates with patterns of interaction, behavior occurring in real-time (or near real-time) with respect to operation or virtualization of an exemplary physical platform.

Consider an example where an operator is proceeding through a virtual training exercise and encounters a live action object (e.g., a person or animal). Contextual data insights can be generated and output (e.g., via virtualization or other means such as auditory) to provide context for that object (e.g., the person has a weapon or does not and is not a threat). In that training, the operator may provide a haptic reaction triggering a sensor where contextual details may be provided to update the operator (e.g., reload). In further examples, the virtualization may be updated to detect a synthetic object or another physical platform, where helpful context can be provided to the operator. In further examples, AI/ML modeling may be created, trained, and adapted to evaluate, audit and/or generate reporting on virtualized training exercises. This can be leveraged to provide useful feedback regarding training exercises but also to train and update AI/ML modeling for future use (including improving accuracy, contextual correlations, etc.).

The present disclosure extends virtual training beyond what is traditionally known while also providing a platform to continuously expand upon. Further, a virtualized representation of an exemplary training space (e.g., battleground space) can be generated, rendered, and displayed from the perspective of a specific device/operator, multiple devices/operators (even different types thereof), synthetic representations of an operator, or overall mapping of a perimeter (e.g., exemplary battlespace) including with the ability to toggle between views of feed representations and/or receive contextual insights, updates, suggestions/recommendations pertaining to an exemplary feed or entirety of a perimeter (e.g., battlespace). In traditional examples, training exercises require a large amount of personnel and resources all in one place to conduct an effective training exercise. The present disclosure resolves this issue by optimizing control and processing efficiency for virtualized training. In further examples of the present disclosure, operators may have control over multi-dimensional virtual environments including viewing specific feeds or aspects of an exemplary perimeter (e.g., battlespace).

Consider an example where an exemplary MANPADS device is being utilized to conduct a training exercise. An operator may configure the physical MANPADS device for usage. As described herein, the device may have a plurality of components (fixed and/or interchangeable), sensors (e.g., pressure sensors, trigger sensors, geometric sensors, audio sensors), and capabilities to enable or replicate real-time operation as a live action object. An operator (or remote operator) can trigger a virtualized training simulation of an environment (e.g., forward-looking battlespace) from the perspective of operator/MANPADS device, a representation of which can be generated rendered and displayed as output via the novel device configuration of the MANPADS device, another connected device (e.g., headset, display) and/or a remotely connected device (e.g., computing device with a display). While operating the MANPADS device, the virtualized representation may be updated to reflect interaction of the MANPADS device, via the operator, with the environment. While in the virtual representation, the operator may receive a contextual update that air support is being received from a supporting team member via another exemplary physical platform (e.g., aircraft device) in real life, entering the environment from overhead. The virtual representation for the MANPADS device may be updated to reflect entry from the aircraft. In some examples, the virtualized representations of physical platforms may be toggled to gain different perspectives of the environment. For example, the MANPADS device operator may wish to gain a perspective of the environment from the perspective of the air support, including representation of a pilot in a flight simulator, which can be reflected via toggling to a live feed view for that exemplary physical platform.

Continuing the example, the virtualized environment is updated with a synthetic object being a bogey in the form of an enemy aircraft. The MANPADS operator may toggle back to the live feed view from its own MANPADS device to be able to properly locate and engage with the synthetic representation of the enemy aircraft. As is highlighted by this example, an adapted virtual environment is immersive, extensible, and scalable, to optimize training exercises while improving realism and mission-focused practical training including in holistic battlefield approaches.

In another non-limiting training example, exemplary physical platforms, for example a MANPADs device, may be utilized for real-life and/or virtualized training of other physical platforms, devices, etc. Consider an example where training may be occurring for an aircraft pilot/aircraft either in a real-world training exercise, virtualized training exercise, or a combination thereof. For instance, an aircraft may be flying in a perimeter of a training area where another operator may be utilizing a MANPADs device on the ground within that perimeter. The operator of MANPADS device may utilize the MANPADS device, in a training mode, to replicate action to try to attack and shoot down the aircraft for training to aid training of the aircraft pilot for situational awareness and tactics related to use of a MANPADs device or similar apparatus. As an example, the MANPADS device may be utilized to lock onto the aircraft and virtually replicate firing upon the aircraft from different vantage points, perspective, etc. A virtualized training exercise for a pilot may be generated and enabled the pilot to engage in a training scenario for handling an interaction with the MANPADS device and operator. In further examples, training operation using one or more physical platforms can be recorded and used to later aid a virtualized training exercise for an exemplary physical platform. In the continued example of aircraft operator tactically training for defense against MANPADS devices, operators of MANPADS devices may record training exercises (e.g., in the perimeter or battlespace) either physically or virtually, and interactions of those operators/MANPADS devices can then be recorded and utilized as a basis for creation a new virtualized training exercise for an aircraft operator (e.g., training in the same perimeter, battlespace, or even a totally different battlespace). In one instance, synthetic feeds can be generated, based on the recordings of the MANPADS virtualized training exercises, or portions or attributes therefrom, and then integrated into an exemplary multi-dimensional virtualized environment for the aircraft training.

Exemplary embodiments of the present disclosure integrate live and virtual environments, wherein the virtual environment can reduce costs, increase training opportunities and training frequency, and improve training quality. The exemplary embodiments described herein combine the real/physical world with the digital or virtual world to create an immersive experiences and quality training. For example, the disclosed system and methods can allow aircrew to combat training to react to both live and simulated threats with several types of simulated weaponry, thereby enhancing aircrew survivability while reducing training cost. In addition, the simulated weaponry can include handheld armaments, such as a MANPADS, which can be 3D-printed.

The exemplary systems and methods described herein provide for generating a virtual collaborative training and platform-agnostic environment that integrates plural platforms to provide a realistic and full-spectrum training experience. The system can adapt to many perspectives across multiple domains, such as air, land, sea, space, and cyber. The exemplary systems and methods utilize a collaborative open architecture resulting in a robust training environment across domains such as an enclave computing domain in which programming code and data are isolated from the operating system and an enterprise domain in safeguards are used to protect an organization's data, networks, and systems from internal and external threats. Exemplary embodiments of the present disclosure can, therefore, ensure operation in Multiple Levels of Security/Multiple Independent Levels of Security (MLS/MILS) environments.

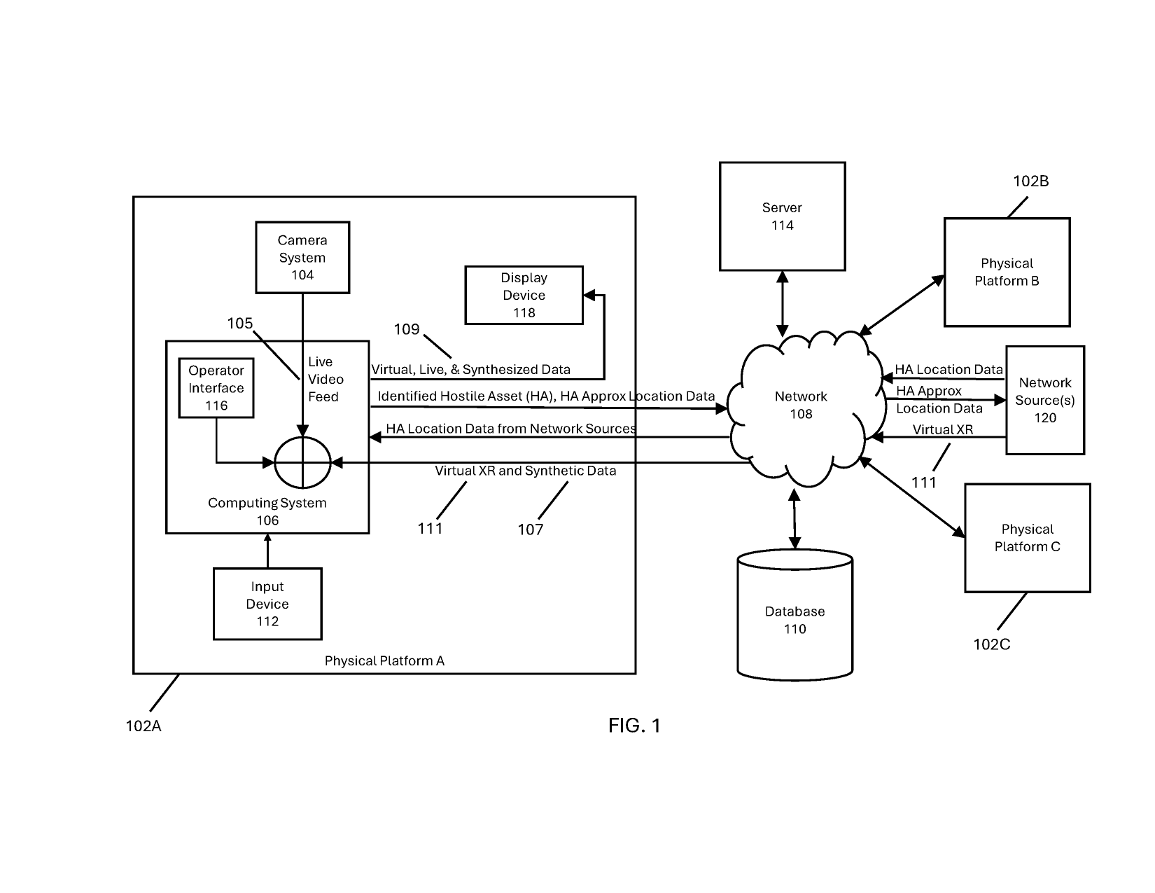

FIG. 1 illustrates a system for generating a virtual training exercise on a physical platform in accordance with an exemplary embodiment of the present disclosure. As shown in FIG. 1, the system 100 includes plural physical platforms 102A, 102B, 102C. Each physical platform is configured for simulated warfighter activities in a battlespace. For example, in one embodiment the physical platforms 102A, 102B, 102C can be configured as a seated or standing simulator for simulating a vehicle configured to travel by air, land, sea, or into space. In another embodiment, the physical platforms 102A, 102B, 102C can be configured as a hand-held or vehicle mounted system, such as a surface-to-air weapon (e.g., MANPADS), surface-to-surface weapon system. Each physical platform 102A, 102B, 102C can include a camera system 104 mounted to or integrated into a structure of the physical platform. The camera system 104 is configured to generate a live video feed 105 for monitoring and surveillance of a battlespace from a point of view of a training location of the physical platform. The exemplary camera system 104 can include one or more cameras or sensors for capturing still or video images of live assets stationed in or moving through the battlespace or combat arena. According to an exemplary embodiment, a live asset can include one or more of a real-world structure, equipment, troops, or vehicles (e.g., air, land, and/or sea), a satellite, a building or home, an air-based target or object or any other suitable stationary or mobile physical asset in the battlespace. The camera system 104 can have a viewing range suitable for achieving the surveillance and target acquisition objective for the weapon configuration of or associated with the physical platform. According to exemplary embodiments disclosed herein, the camera system 104 can be configured for detecting visible light, infrared radiation, thermal radiation, or any other suitable imaging technology as desired. In another embodiment, the camera system can be or configured to be mounted to one or more of a stationary or moving object such as a person (e.g., body-worn camera), vehicle, building, weapon, robotic machine, or any other suitable component as desired. According to another embodiment, the camera can be mounted to geological or biological structures such as a tree, rock, plant, mound, animal, nest, or other suitable naturally occurring or creature-created structure within the battlespace or combat area.

Upon receiving the live video feed 105 from the camera system 104, the computing system 106 can be configured to perform an object detection or object tracking operation with respect to one or more live assets that are either stationary within or moving through the battlespace. The computing system 106 can employ one or more of known and suitable object detection and/or object tracking systems as desired. Upon detecting one or more live assets from the live video, the computing system 106 can identify the type and/or model of each detected asset. For example, the computing system 106 can extract one or more features of each live asset from the live video feed 105. The extracted features of each live asset can be compared to a database of features associated with known assets of a similar type. From the initial detection and/or tracking operation, the computing system 106 can determine whether the live asset is a human, stationary structure, or vehicle, as well as, the type of structure and/or vehicle that is detected. From this determination, the computing system 106 can access one or more remote databases and/or modeling platforms over a network 108 and compare the features extracted from each of the one or more detected live assets to a database of known assets. Based on the result of the comparison, the computing system 104 can identify each detected live asset in the live video feed 105 based on a comparison result.

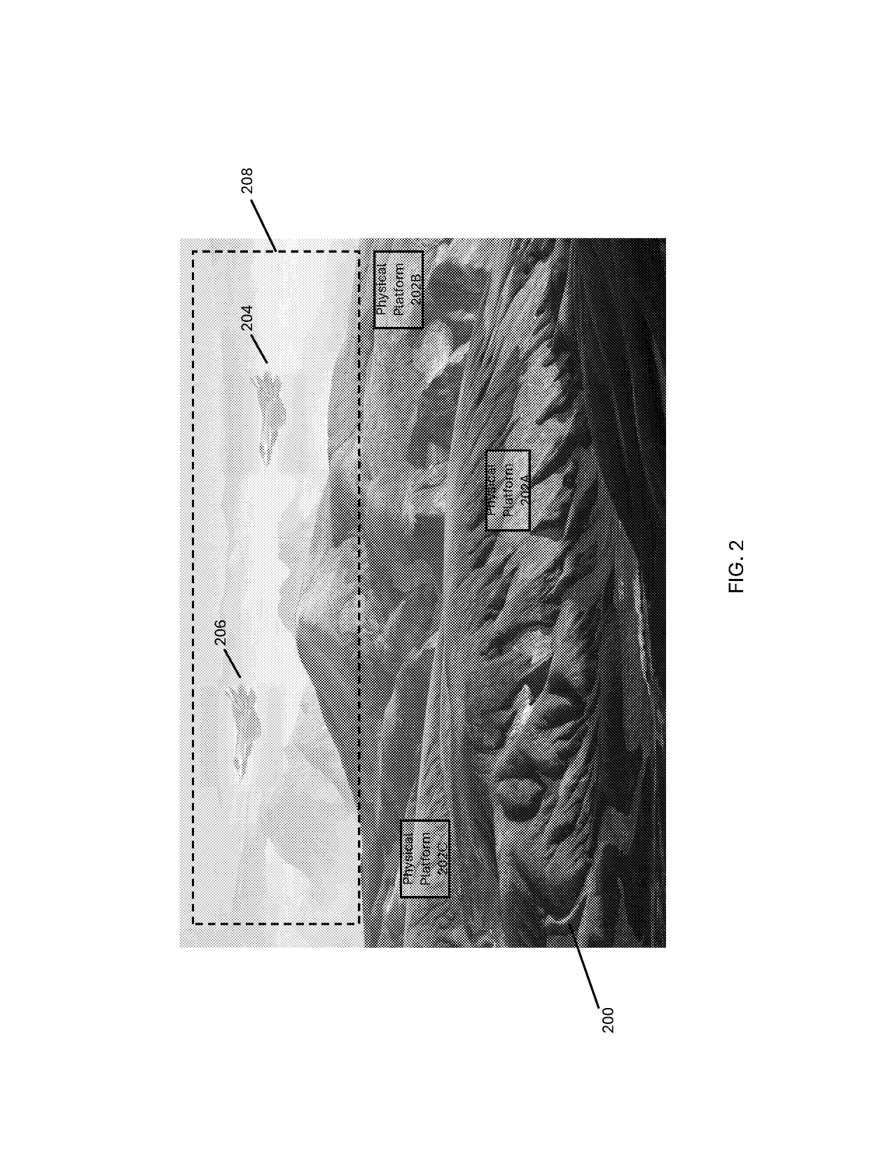

FIG. 2 illustrates an arrangement of the system in a battlespace according to an exemplary embodiment of the present disclosure.

As shown in FIG. 2, each physical platform 102A, 102B, 102C can include a computing system 106 configured to inject synthetic data 206 into the live video feed 208 based on the one or more detected live assets 204. The physical platforms 102A, 102B, 102C can be connected to access a database 110 over the network 108. The database 110 can be configured to store at least synthetic models of assets, such as synthetic models of structures, vehicles (e.g., air, land, or sea) of military allies or adversaries, uniforms or clothing worn by military allies or adversaries, weapons (e.g., knives, guns, artillery, etc.). For example, the computing system 106 can be connected to plural modeling platforms 120 for receiving extended reality data 111, and synthetic data 107. Once each live asset 204 in the video feed 208 is identified, the computing system 106 can obtain a synthetic model 206 for each live asset 204. According to an exemplary embodiment, the computing system 106 can search one or more databases for the synthetic data 107 based on each identified live asset 204. The search can also be performed based on one or more search parameters in addition to the one or more live assets 204 which have been identified. According to an embodiment, the computing system 106 can include an input device 112 whereby the search parameter(s) can be provided. For example, the user or operator can navigate to a screen of the graphical display using one or more pull down menus, so that the search parameter(s) can be input into one or more search fields and the search can be initiated. Search parameter(s) can be input globally for a collection of live assets 204 or can be input individually for the one or more assets 204.

Once the search is initiated, the computing system 106 can access the one or more databases 110 over the network 108 and extract a three-dimensional (3D) model for each live asset 204 from the one or more databases, the 3D model being extracted being identified as a match to the one or more search parameters for each live asset 204. The network 108 can include open-source information and/or data associated with one or more sensitive (e.g., classified) and/or closed-loop sources. In addition, the network 108 can be configured secure and/or private network that is isolated from public access and that is accessible only to authorized users and devices, and protected by security measures such as passwords, encryption, and firewalls. According to an exemplary embodiment, the extracted 3D model can also be matched to the one or more identified live assets 204 without the user-input search parameters.

The synthetic data can include manned synthetic entities such as vehicles, aircraft, and people other than the synthetic entities that are completely flyable, drivable synthetics: man-in-loop aircraft, high-fidelity vehicles, naval vessels, and targets. The extended reality data 111 can include data that augments the live video feed of the battlespace by including additional elements of the battlespace according to the specified training event. For example, the extended reality data 111 can generate a high-fidelity visual environment by augmenting the live video feed with details such as humans, animals, weather, weapons, vehicles, roads, buildings, trees, and cultural features. In addition, extended reality data 111 can include features such as weather, airspace, air-to-air weapons, radar, aerodynamics, communications, datalinks, radar cross section, and other suitable features as desired for the training mission. Still further, the extended reality data 111 can include a dense threat environment, realistic array of targets including target vulnerability data, high fidelity terrain models, high fidelity target complexes, and weapons data including lethality models.

According to an exemplary embodiment, the plural modeling platforms 120 can generate extended reality data 111 for training ranges, airspaces, threat systems, and control centers and can be arranged in a node-based enterprise. The computing system 106 can be configured to integrate the data provided by the plural modeling platforms 120, where the computing system 106 and the plural modeling platforms 120 are arranged and connected in a node-based enterprise, integrating range systems’ capabilities to enable blended, live and synthetic training in a multi-level of security (MILS) environment. Based on an exemplary arrangement, the computing system 106 can simulate a large variety of operational systems or use cases using a hardware and software configuration as described in the present disclosure. According to an exemplary embodiment, the computing system 106 is configured to be hardware and software agnostic, which enables flexibility in tailoring specific training objectives or mission sets for physical platform 102A. Further, computing system 106 can be adapted to specific training requirements and scaled to any mission rehearsal use case at an accelerated rate while minimizing overall system footprint.

The extended reality data 111 can generate synthetic avatars of live players that “follow” live actions in the battlespace or common operational environment. According to an exemplary embodiment, the synthetic avatars can be “attached” to live SAM locations. A digital air defense system can be generated and controlled, such that when a live SAM launches, the system can perform a constructive flyout based on live Time, Space, Position Information (TSPI), and threat data. In another example, a live aircraft can be generated and processor- and/or computer-controlled to perform constructive air-to-ground or air-to-air weapons flyouts, synthetic electronic warfare, expendables, and other suitable maneuvers and/or operations as desired. These exercises can be performed even in areas where those capabilities may be restricted in live airspace due to environmental or security concerns. The extended reality data 111 can also control a digital system to react to an event based on mission data obtained from documents defining the mission. The extended reality data 111 can also augment the live video feed by generating weather features, terrain features and other natural or man-made structures which realistically impact radar detection, communication, flight operations, and ground operations.

The computing system 106 can be configured to transmit the live asset 204 and synthetic asset 206 to a central server 114 so that data and/or information concerning both assets 204, 206 can be obtained by and/or automatically sent to one or more other physical platforms 202B, 202C in the battlespace or combat arena 200 for the training exercise.

According to an exemplary embodiment, the computing device 106 can be configured to generate data for localizing the one or more live assets in the battlespace. The computing device 106 can be configured to correlate the one or more live assets in a live feed for context, distance, and proximity to an associated physical platforms 102A. For example, the computing device 106 can estimate a distance from the camera system 104 of the physical platform 102A to a point on the detected live asset. The computing device 106 can use the estimated distance to generate first distance information that includes a view angle of the physical platform 102A, coordinates of the physical platform 102A in the battlespace, or any other data that can be used to localize the physical platform 102A as desired. The computing device 106 can send the first distance information to the central server 114 for access by one or more other physical platforms 102B, 102C in the battlespace.

The computing system 106 of physical platform 102A can communicate with the central server 114 to receive at least second distance information from another physical platform 102B, 102C having a different point of view of a live asset in the battlespace. According to an exemplary embodiment, the second distance information includes location data, such a view angle, coordinates, geospatial data, geolocation data of the live asset from the point of view of the other physical platforms 102B, 102C in the battlespace. The computing device 106 can localize and/or use triangulation to determine the location of the identified live asset in the battlespace using the first distance information and the second distance information.

According to an exemplary embodiment, one or more live assets may be occluded or not observable or detectable by the computing system 106 in the live video feed generated by the physical platform 102A. The computing system 106 can communicate with the central server 114 to receive data and information from another physical platform 102B, 102C having a different point of view of the battlespace. For example, one or more of the physical platforms 102B, 102C can generate a live video feed from a perspective in the battlespace that includes the information and/or data of the one or more live assets that are not observable or detectable by the physical platform 102A. The computing device 106 can correlate the information and data of the one or more unobservable or undetectable live assets in the live feed for context, distance, and proximity to the associated physical platform 102A. In addition, the computing device 106 can use the information and data of the one or more unobservable or undetectable live assets to generate proximity, location, and/or directional information for display at the physical platform 102A. For example, when the one or more unobservable or undetectable live assets are still out of a line of sight or viewing angle of the physical platform 102A, the proximity, location, and/or directional information received by the computing system 106 can be used to provide indicators for tracking a location, direction, and/or proximity of the one or more unobservable or undetectable live assets at the physical platform 102A. According to one embodiment, the location, direction, and/or proximity information can include a speed, direction of movement, a current geospatial coordinate, a distance to/from, an identification, and/or any other suitable attributes of an unobservable or undetectable live asset as desired.

According to another embodiment, the one or more live assets can include a stationary object, such as a man-made or naturally occurring structure, a human or personal effects of a human, a vehicle, or a machine in the battlespace or arena. The personal effect can include, for example, clothing, jewelry, a weapon, wallet, purse, shoe(s), or any other item of individual property that can be worn or carried by an individual. In one example, the stationary object can be occluded from view and is not otherwise observable or detectable in the live video feed generated by the physical platform 102A. As already discussed, the computing system 106 can communicate with the central server 114 to receive data and information related to the stationary object(s) from another physical platform 102B, 102C having a different point of view of the battlespace. The computing system 106 can synthesize the live video feeds of the physical platforms 102A, 102B, and 102C such that even though the stationary object(s) may remain occluded from view at the physical platform 102A, the live video feed can include overlay information that indicates location, direction, proximity, and/or identification of the stationary object(s).

The computing system 106 can be configured to generate an operator interface 116 that replicates the actual operator controls of the real equipment that the physical platform 102A is designed to simulate. By integrating the extended reality data 111 of the plural platforms, the computing system 106 can generate synthesized data by combining an operator interface 116 associated with the physical platform, the live video feed 105 including the detected live asset and the synthetic data 107, wherein the operator interface 116 is overlayed onto the live video feed 105 and the synthetic data 107 is controlled to move in a specified alignment relative to the detected live asset. For example, according to an exemplary embodiment, an operator interface 116 can be generated for a simulated Surface to Air Missile (SAM) system. The computing system 106 can be generated as an operator-in-the-loop threat role playing station (RPS) that provides training and feedback to the real and/or targeted synthetic aircraft. The operator interface 116 can be configured to receive input from a user as well as data inputs from one or more of the plural platforms such that move the synthetic asset in alignment with the live asset, where the movements are intended to defeat or survive the engagement by the SAM system. According to another exemplary embodiment, the computer system 106 can be configured to generate an operator interface 116 that emulates the track and firing characteristics of a MANPAD. The operator interface 116 can receive the data from the plural platforms to allow for targeting both live and synthetic assets.

As shown in FIG. 1, the physical platform 102A can include a display device 118. The display device 118 can be any type of known display. According to an exemplary embodiment, the display device 118 can include a component used to present a graphic display, such as the operator interface 116, which includes at least one or a combination of the live video feed 105, synthetic data 107, extended reality data 111, and synthesized data 109. According to an exemplary embodiment, the display device 118 can be configured to receive and/or generate a graphic display that includes graphical elements used for controlling operation of the physical platform 102A for performing surveillance or tracking of the live asset, and/or targeting of the live asset during the training exercise. The display device 118 can include one or more known features or configurations such as a touchscreen for receiving physical input from a user or operator. The display device 118 can be configured to generate a graphical interface for displaying the synthesized data.

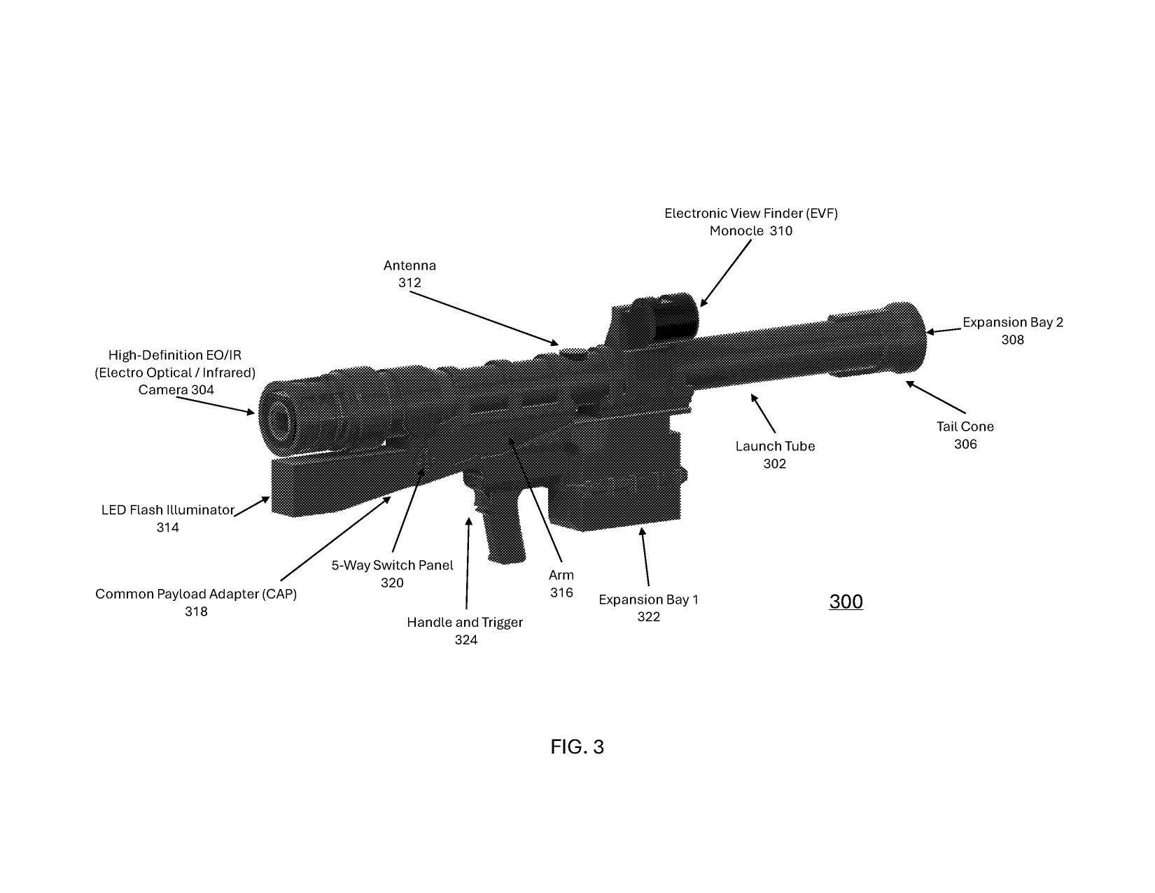

FIG. 3 illustrates a physical platform in accordance with an exemplary embodiment of the present disclosure. As shown in FIG. 3, a physical platform 102A, 102B, 102C can be configured as a role-playing station (RPS) for conducting training in a battlespace. According to an exemplary embodiment, the RPS can be in the form of a MANPADS 300. The MANPADS 300 is configured for training and simulating combat situations in a battlespace. However, for real-life simulation and a realistic training experience, the MANPADS 300 is designed to have the look and feel of a real weapon that is used with live ammunition. The MANPADS 300 can include a launch tube 302. At a distal end with respect to an operator, the launch tube 302 can include a high-definition electro optical/infrared camera 304. At a proximal end, the launch tube 302 can include a tail cone 306 and an expansion bay 308. A monocle 310, such as an electronic view finder, can be arranged on the launch tube at a suitable position for use and/or interaction by the operator. The monocle 310 can be connected to receive the live feed from the camera 304 and is configured to generate an operator interface that is overlayed on the live feed. By the operator interface, the monocle 310 can capture a live asset as it travels through the battlespace. According to an exemplary embodiment, the MANPADS 300 can connect to the network 108 and receive information regarding the location of a live asset that is being targeted and tracked by another MANPADS 300 within the battlespace. The monocle 310 can be configured to display one or any combination of graphics, text, and icons, which guide or instruct the operator to adjust the positioning of the MANPADS 300 so that the live asset can be captured by the camera 304. For example, the graphics, text, and/or icons can indicate directional information so that the position of the MANPADS can be adjusted (e.g., pan left, pan right, pan up, pan down) so that the live asset is within the line of sight of the camera 304. According to an exemplary embodiment, the MANPADS 300 can communicate with the server to obtain one or more synthetic assets that were integrated into the live feed from another MANPADS device. In this manner, the operators of plural MANPADSs in a battlespace can share a common combat training experience. The launch tube can also include one or more antennas 312 for communication with a wireless network. For example, the antenna 312 can be configured to connect to the global positioning system (GPS) or any other suitable network for communicating position and/or data. At the distal end, an LED flash illuminator 314 can be arranged to extend from the launch tube 302 via an arm 316 to a location below the camera 304. The arm 316 can also include a common payload adapter 318 that provides an interface for connection to an external computing device through one or more physical ports. The arm 316 can further include a switch panel 320 for interacting with the operator interface displayed on the monocle 310. An expansion bay 322 can extend orthogonally from an approximate midpoint of the launch tube 302. The expansion bay 322 can include a handle and trigger component 324 that enables the operator to engage a live asset that appears in the monocle 310.

In one example, the MANPADS 300 may serve as a Role Player Station (RPS) that has an integrated camera (e.g., boresight camera) for evaluation and recording and other internal/mounted hardware which turn time, time-space-position information (TSPI) into a physics-based model with assessment capability. AR allows viewing of the digital models, and integration with other apparatus/devices/systems including the ability to provide launch indications (e.g., visual and/or auditory) to a live or virtual simulated objects (e.g., an aircraft). Further, the MANPADS 300 is configured to connect or synchronize (including multi-directionally) with other devices, including through remote, networked connection, for transmission of information including states of operation, simulation views, actions/recommendations, notifications. MANPADS 300 may comprise one or more integrated cameras (color/night vision) may be fixed or modular, including made adjustable for positioning, angle, telescoping, etc., which, when adjusted, can correlate to an adjustment of a virtualized representation (e.g., from the perspective of a corresponding physical platform).

An exemplary hyper-realistic physics-based virtual model (e.g., Modern Air Combat Environment) is adapted to enable realistic contextual rendering and can engage multiple LVC targets simultaneously, including non-limiting operations, as examples, such as ability to enable: scanning; aiming; missile seeking; real-time hit/miss assessment; validated physics-based weapons flyouts, modifiable IR signatures of aircraft, vehicles, lifeforms, etc., constructive Infrared Counter-Countermeasures modeling, modeling of environment including terrain and weather to simulate realistic IR seeker performance, AR image generator enables viewing of the digital model environment and flyouts for both gunner and mission observers/spotter, mission record capability captures aircraft TSPI, threat reactions, and supports playback/debrief and network streaming as well as connections with communication kits (e.g., hardware/software providing a local mesh network(s) with 5G/Wi-Fi/Starlink, AI/ML modeling, third-party software programs, modules, etc., GUI rendering including provision of contextual information (e.g., data insights, alerts, notifications)0.

According to an exemplary embodiment, the physical features of the MANPADS, excluding for example, the camera, antenna, monocle, physical ports, etc., can be generated through three-dimensional (3D) printing technology. The lightweight nature of the 3D-printed components, combined with the compact camera system, ensures the system remains highly portable for real-world field training scenarios.

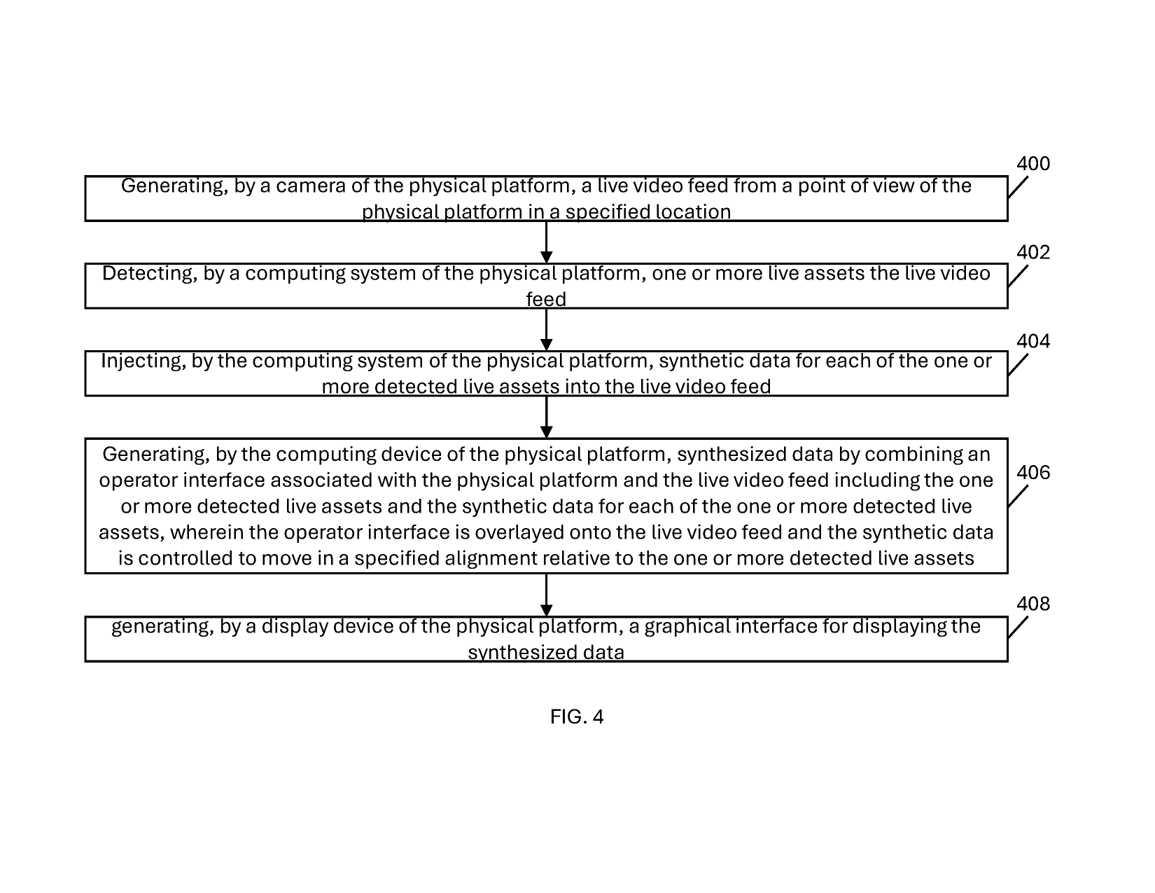

FIG. 4 illustrates a method for generating a virtual training exercise on a physical platform 102A in accordance with an exemplary embodiment of the present disclosure. The method includes generating, by the camera 104 of the physical platform 102A, a live video feed 105 from a point of view of the physical platform 102A in a training location, such as a battlespace (Step 400). The computing system 106 of the physical platform 102A, detects one or more live assets 130 in the live video feed 105 (Step 402). The computing system 106 injects synthetic data 107 into the live video feed 105 based on the one or more detected live assets 130 (Step 404). The synthetic data 107 can include a synthetic asset for each of the detected live assets, where the synthetic asset is obtained from a remote or external network source 120. This operation can also include injecting extended reality data 111 into the live video feed 105. The extended reality data 111 can also be obtained from one or more external sources 120 on the network 108. The method further includes the computing system 106 generating synthesized data 109 by combining an operator interface 116 associated with the physical platform 102A and the live video feed 105 including the one or more live assets 130 and the synthetic data (e.g., synthetic asset(s) for each live asset) 107 (Step 406). The computing system 106 overlays the operator interface 116 onto the live video feed 105. As described herein, the live asset 130 can be a stationary or a mobile object. In one example, the synthetic data 107, 206 that is injected into the live video feed 105 is controlled to move in a specified alignment relative to the movement of the live asset 204. The method further includes generating, by the display device 118, a graphical interface for displaying the synthesized data. According to an exemplary embodiment, the display device 118 can display one or any combination of the live video feed 105, the synthetic data 107, and the synthesized data 109.

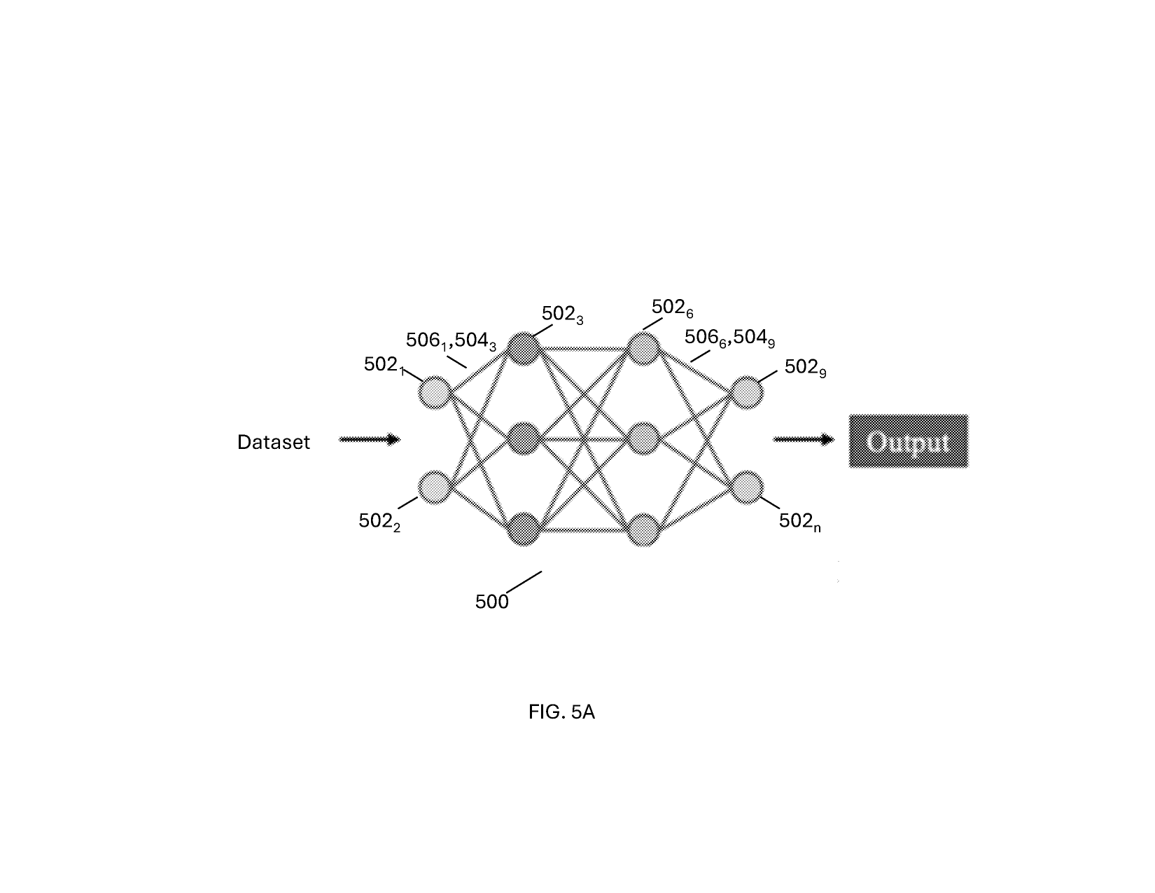

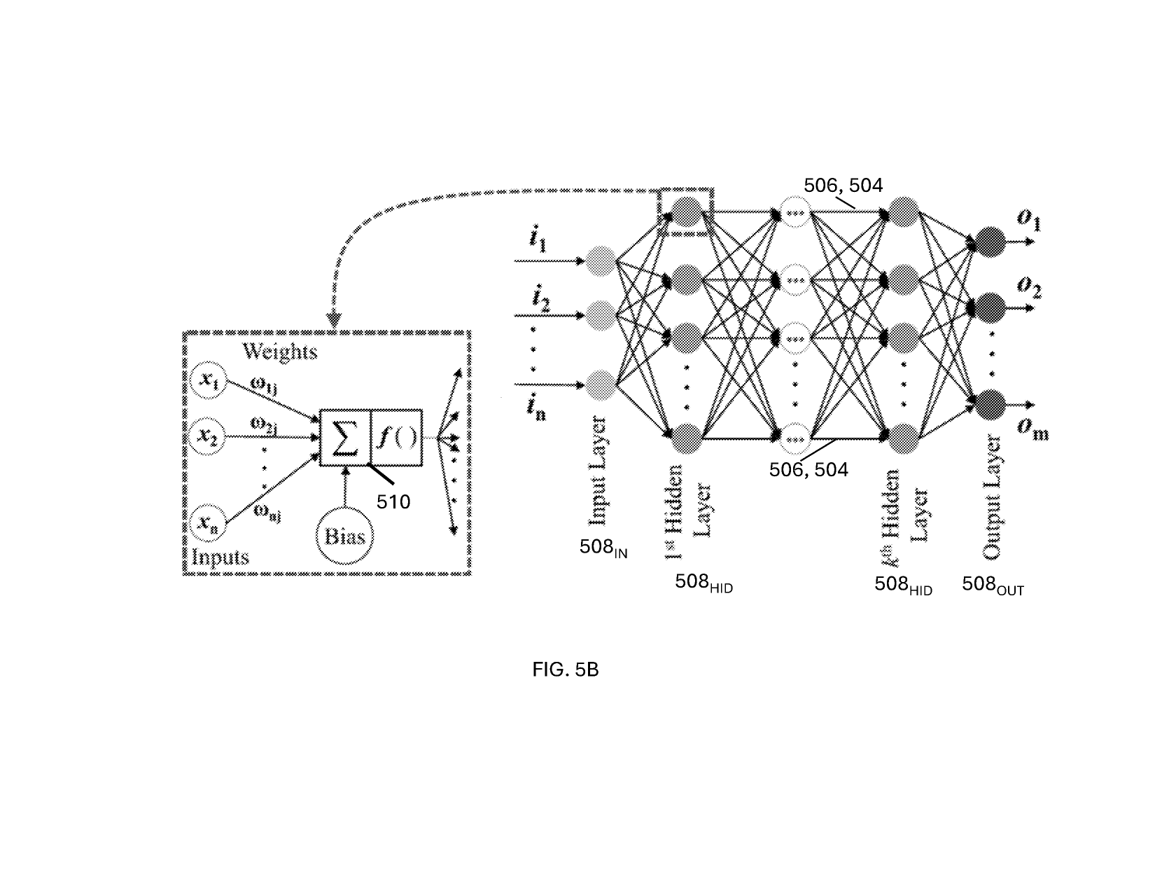

FIGS. 5A and 5B illustrate a deep learning neural network in accordance with an exemplary embodiment of the present disclosure. The system 100 can include a deep learning neural network architecture that utilizes natural language processing and artificial intelligence to dynamically process data from user documents, such as military orders issued by a leader to their subordinates to help coordinate a military operation, to automatically generate simulations to increase efficiency of planning. The computing system can be configured to execute one or more models of the neural network architecture simulate and analyze exercises from multiple perspectives, with complex, real-world, real-time data layers to enhance an understanding of an exercise. As a result, users can improve exercises and mitigate risks in the real-world exercises based on the training exercise(s). In addition, the neural network architecture can include one or more models for generating real-time analytics on aviator performance for training and qualification exercises. The model(s) can be configured and/or trained to perform predictive analytics for predicting aviator responses based on previous performance as well as enemy actions. The model output can be used to generate an individually tailored training and/or recommended track or action points for each individual aviator, such that the computer system 106 can augment the operator interface to display tailored features in a helmet mounted targeting system of the aviator.

In another example, model(s) of the neural network architecture can be configured to generate cyber effects for injection into a training environment. For example, the model(s) can be trained to generate anomalies in radio frequency (RF) and/or network/IP data communication to simulate cyber threats and attacks within satellites and datalinks.

The neural network can include plural nodes that represent individual computational units. Each node has one or more biased input/output connections that function as transfer or activation functions for combining the inputs and outputs in a specified manner. As shown in FIG. 5A the neural network 500 includes plural nodes 502₁ to 502ₙ where each node 502ₙ has one or more inputs (i) 504 and outputs (o) 506 for processing the data. The neural network 500 is formed by an arrangement of the plural nodes 502ₙ into multiple layers 508, the scheme within which the nodes 502ₙ are connected determines the type and operation of the neural network 500. For example, as shown in FIG. 5B, the neural network 500 can include an input layer 508_{IN}, multiple hidden layers 508_{HID}, and an output layer 508_{OUT}. Each layer 508 may perform a different or specified transformation on the respective inputs, using a different or specified mathematical calculation or function. Signals travel or are passed between the layers 508, from the input layer 508_{IL} to the output layer 508_{OUT} via the middle or hidden layers 508_{HID} and can traverse any layer 508 and node(s) 502 multiple times. As shown in FIG. 5B, the nodes 502ₙ can be connected in an array and each node can transmit a signal to a node in another layer 508 of the neural network 500. The input/output connections 504,506 between the nodes have a corresponding weight wₙⱼ and are combined according to the bias applied at each node. For example, the connections 504506 are activation or transfer functions which trigger the respective nodes and combine inputs according to mathematical equations or formulas 510 according to the bias. According to these neural network principles, and as shown in FIG. 5B, the data is received at an input layer 508_{IN} of the neural network 500 and passed through multiple hidden layers 508_{HID} for generating a virtual training exercise on a physical platform. According to exemplary embodiments of the present disclosure, learning actions of the neural network can be achieved by feedback an output and updating of node weights based on the feedback. The neural network can be executed by the computing system 106 and/or by an external or remote processing device accessible through the network 108. In one embodiment, using one or more trained models of the neural network architecture, the computing system 106 can be configured to generate one or more extended reality features described herein for injection into the live video feed for augmenting the training experience and/or training environment.

In any example described herein, artificial intelligence and/or machine learning (AI/ML) models may be employed to analyze input data and generate predictions, classifications, data insights, or recommendations. Furthermore, one or more management components may interface with AI/ML components to enable automated execution of tasks and actions to achieve practical applications described herein. As an example, a result generated by AI/ML modeling may be leveraged to trigger execution of automated decisions, raise inflection points, notifications, and modify process flow, among other non-limiting examples. Additionally, exemplary AI/ML modeling may further be integrated into a software data platform to enable data ingestion and connection to data endpoints and services which may feed critical and novel data (and metadata), including exemplary signal data, to AI/ML modeling for continuous processing. This can include continuous provision of feedback for enhanced training and adaptation of AI/ML modeling as well as various types of signal data described herein that can provide customized and novel real-time (near real-time) contextual analysis of integrated applications/services.

The AI/ML models described herein may include, without limitation, supervised learning models, unsupervised learning models, reinforcement learning models, deep learning neural networks, transformer-based architectures, ensemble models, or hybrid combinations thereof. Input data may comprise but is not limited structured, semi-structured, and/or unstructured data, and further comprise any type of record or documentation including but not limited to: numerical records, categorical data, textual data, audio, video, sensor data, network activity, web pages, documents, messages e.g., text or chat), social media, historical project outcomes, knowledge graphs, and ontology. Preprocessing operations may include feature extraction, dimensionality reduction, normalization, tokenization, vectorization, embedding generation, and/or transformation into numerical representations suitable for model consumption. Non-limiting examples of types of data layers may comprise but are not limited to: raw data layers, pre-processing or clean-up layers, feature engineering or transformation layers, embedding layers (e.g., word embedding, node embeddings, latent learned features), model input layers, hidden or intermediate layers (e.g., neural network specific such as convolution layers, recurrent/temporal layers, transformer/self-attention layers), output or scoring layers (e.g., SoftMax, regression, ranking), post-processing layers (e.g., re-rank, weighting, filtering), and feedback or reinforcement layers (training and re-ranking based on collected signal data). Data layers may further incorporate metadata, contextual attributes, and/or weighting factors customized/defined by users including those derived from organizational data (e.g., guidelines, performance history, or user preferences).

Non-limiting examples of supervised learning that may be applied comprise but are not limited to: nearest neighbor processing; naive bayes classification processing; decision trees; random forests; gradient boosting; linear regression; support vector machines (SVM) neural networks (e.g., convolutional neural network (CNN) or recurrent neural network (RNN)); and transformers, among other examples. Non-limiting examples of unsupervised learning that may be applied comprise but are not limited to: application of clustering processing including k-means for clustering problems, hierarchical clustering, mixture modeling, other dimensionality reduction, etc.; application of association rule learning; application of latent variable modeling; anomaly detection; and neural network processing, among other examples. Non-limiting examples of semi-supervised learning that may be applied comprise but are not limited to assumption determination processing; generative modeling; low-density separation processing and graph-based method processing, among other examples. Non-limiting examples of reinforcement learning that may be applied comprise but are not limited to value-based processing; policy-based processing (policy gradient methods); and model-based processing, Q-learning, among other examples. Non-limiting examples of transformer models comprise but are not limited to encoder-decoder architectures, attention-based mechanisms, and large language models (e.g., contextual embeddings, sequence-to-sequence learning), among other examples. Non-limiting examples of ensemble models comprise but are not limited to combinations of classifiers or regressors (e.g., boosting, bagging, stacking), voting/aggregation (e.g., majority or weighted voting), Bayesian averaging, ensemble neural networks, snapshot ensembles, or dropout ensembles, among other examples.

Multiple AI/ML layers may be combined, wherein a rules-based layer enforces hard constraints, while a machine learning layer optimizes within permissible solution spaces. Transformer-based embeddings may be combined with clustering methods to identify latent structures in key data sets (e.g., workforce or project data). Graph-based models may represent relationships between entities (e.g., employees, skills, roles, teams), while reinforcement learning layers optimize data points (e.g., assignments, roles, responsibilities) over repeated simulations.

In any AI/ML example, models are continuously trained and optimized to adapt and improve performance and accuracy. Training may comprise but is not limited to forward propagation, backpropagation, gradient descent, stochastic gradient optimization, hyperparameter tuning, and/or automated model selection, or a combination thereof. Training datasets, validation datasets, and test datasets may be partitioned according to standard practices or dynamically adjusted based on input constraints. Loss functions may further be applied to minimize loss and improve accuracy. Loss functions may comprise but are not limited to cross-entropy, mean squared error, hinge loss, cosine similarity, or domain-specific cost functions, among other examples. Weights, biases, and other parameters may be updated iteratively to minimize loss functions while maximizing predictive performance.

Additionally, AI/ML processing may comprise scoring, ranking, and weighting to optimize output. Model outputs may include raw prediction scores, probability distributions, confidence intervals, or ranked recommendation lists, among other non-limiting examples. Scoring functions may incorporate weighting factors set by administrative users, defined in documentation (e.g., internal guidelines, user-defined constraints, business rules, or supervisory input), knowledge graphs, or a combination thereof, among other examples. Ranking mechanisms may generate ordered lists of candidate outputs (e.g., role assignments, matches, or classifications), optimized according to multiple objective functions (accuracy, diversity, compliance). In some examples, ensemble scoring may be used, wherein multiple models contribute weighted outputs to produce a final ranking or classification.

Furthermore, AI/ML modeling can be further adapted to enhance intelligible understanding and guide usage of output. Model interpretability may be enhanced using feature attribution methods (e.g., Local Interpretable Model-agnostic Explanations (LIME)), attention visualizations, or surrogate models, among other examples. Outputs may be accompanied by context, descriptions, explanations, etc. that indicate the most significant contributing factors or features, provide comparative analysis, suggestions, recommendations, etc. Human-in-the-loop feedback may be incorporated, enabling iterative retraining and calibration of model behavior. Fairness and bias-mitigation techniques may be employed, including re-weighting, counterfactual fairness testing, or adversarial debiasing.

Moreover, models may be deployed as application programming interfaces (APIs), microservices, or embedded modules within larger enterprise systems including via widgets, iFrames, etc. Real-time inference engines may support streaming data, while batch inference may be used for periodic or large-scale analysis. Models may be updated dynamically, retrained periodically, or adapted through web-based learning modules (e.g., cloud computing). Furthermore, AI/ML models described herein may be implemented using cloud-based platforms, distributed computing systems, edge devices, or hybrid architectures. Storage may be supported by relational databases, graph databases, data warehouses, or vector databases optimized for embeddings. Moreover, training and modeling may comprise a hybrid approach leveraging additional technologies and capabilities including but not limited to: plural AI/ML models, Parallelization, GPU acceleration, specialized hardware (e.g., TPUs), quantum computing, hybrid quantum/AI-ML solutions may be utilized for efficient training, inference, and acceleration of AI/ML modeling for complex problem solutions. For instance, hybrid AI/ML and quantum computing technology may be integrated and used to solve complex matters such as simulations, encryption, large-scale optimization, among other examples.

The present disclosure is further adapted to enable trained AI/ML modeling to integrate with data endpoints of applications or services (including third-party integrations) processing to collect real-time (or near real-time) signal data for improved processing efficiency, enhanced accuracy, improved training, and the adaptation of AI/ML modeling for practical applications, among other technical advantages. For instance, application of trained AI processing (e.g., one or more trained machine learning models) may be adapted to evaluate data endpoints pertaining to users within an organization (e.g., individuals, teams or project groups), signal data from data endpoints from third-party data integrations, user actions including past and/or current user actions, user preferences or settings, application/service log data, etc., This additional signal data analysis may help yield determinations as to enhancing decision points and outputs, determining how (and/or when) to automate decision processing, raise notifications including recommendations/suggestions, and generation and management of data insights, among other examples.

Non-limiting examples of signal data that may be collected and analyzed comprises but is not limited to: device-specific signal data collected from operation of one or more user computing devices; user-specific signal data collected from specific tenants/user-accounts with respect to access to any of: devices, login to a distributed software platform, applications/services, etc.; application-specific data collected from usage of applications/services and associated endpoints; profile data, internal documentation (e.g., policies, guidelines, organizational values), third-party integrations (e.g., client apps, social media, etc.) or a combination thereof. Analysis of such types of signal data in an aggregate manner may be useful in helping generate contextually relevant determinations, data insights, etc. Analysis of exemplary signal data may comprise identifying correlations and relationships between the different types of signal data, where telemetric analysis may be applied to generate determinations with respect to a contextual state of user activity with respect to different host application/services and associated endpoints. Analyzing signal data, including user-specific signal data, occurs in compliance with user privacy regulations and policies. For instance, users may consent (or opt-in) to monitor signal data to improve user experience and operation of applications/services associated with a software data platform.

Additionally, the present disclosure may further comprise one or more application/service components configured to manage host applications/services and associated endpoints. The application/service component may be further configured to present, through interfacing with other computer components described herein, an adapted graphical user interface (GUI) that provides user notifications, GUI menus, GUI elements, etc., to manage front-end representation of the present disclosure including the ability to execute processing operations and methods (e.g., computer-implemented methods) described herein. An application/service component may further be configured to manage different versions or representations of the present disclosure that are packaged for user access. For example, a stand-alone version of a role-based mapping management app/service may be providable for access by users. In one instance, this may be a SaaS implementation where organizational users may access services described herein via a tenant (e.g., dedicated or shared). In other examples, the present disclosure may be integrable as a component to interface within an organizational software data platform, for instance, which can further tie into additional organizational data endpoints, among other examples.

In any case, an application/service component further manages respective endpoints associated with individual host applications/services, which have been referenced in the foregoing description. In some examples, an exemplary host application/service may be a component of a distributed software platform (e.g., cloud computing platform) providing a suite of host applications/services and associated endpoints, services, microservices, etc. A distributed software platform is configured to provide access to a plurality of applications/services, thereby enabling cross-application/service usage to enhance functionality of a specific application/service at run-time. For instance, a distributed software platform enables interfacing between a host service related to management of a distributed collaborative canvas and/or individual components associated therewith and other host application/service endpoints (e.g., configured for execution of specific tasks). Distributed software platforms may further manage tenant configurations/user accounts to manage access to features, applications/services, etc. as well as access to distributed data storage (including user-specific distributed data storage), and distributed knowledge repositories. Moreover, specific host application/services (including those of a distributed software platform) may be configured to interface with other non-proprietary application/services (e.g., third-party applications/services) to extend functionality including data transformation and associated implementation. Role-based access control (RBAC) may be implemented to manage permissions and privileges for access to data described herein.

An exemplary application/service component is further configured to present, through interfacing with computer processing devices, an adapted GUI that provides user notifications, GUI menus, GUI features, etc. The GUI may comprise interactive components such as GUI elements, dashboards, visualization panels, report generation and management, input fields for receiving user selections and parameters, and feedback, among other examples. The system may further generate and present real-time notifications, alerts, or recommendations to the GUI, including contextualized data insights derived from analytics engines or AI/ML models. Such insights may be rendered as charts, tables, or ranked lists, and may dynamically update in response to new data inputs, user actions, or system-detected events, for example, based on processing of exemplary signal data described herein. A GUI processing layer may further be implemented to support adaptive layouts, prioritization of displayed information based on relevance scores, and customizable notification preferences to enhance usability and decision-making. In further examples, a GUI is generated and adapted to manage AI/ML modeling including administrative features/functionalities and controls as described in the foregoing, all of which may be further created customized, adapted, AI/ML modeling.

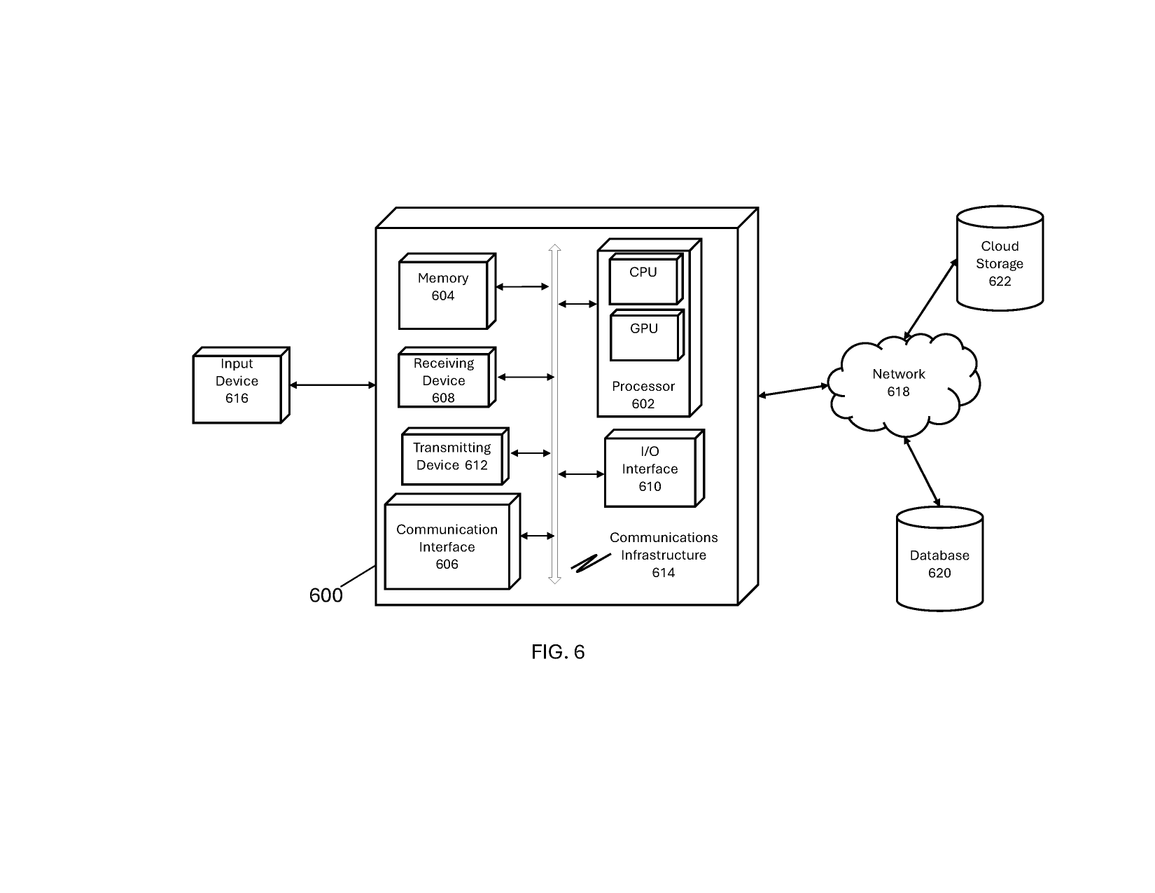

FIG. 6 illustrates a hardware configuration of a computing device in accordance with an exemplary embodiment of the present disclosure. As shown in FIG. 6, the computing system/device 600 may include a processor (e.g., CPU) 602 and memory 604. The processor 602 may execute software instructions (e.g., program code) for generating a virtual training exercise on a physical platform as disclosed herein. The computing system/device 600 as disclosed herein, can be configured for training one or more machine learning and/or artificial intelligence models (e.g., neural models, neural networks, and/or the like) and for generating a virtual training exercise on a physical platform with one or more trained machine learning models.

The processor 602 may be implemented in hardware, software, or a combination of hardware and software. For example, the processor 602 may include a Reduced Instruction Set Core (RISC) processor, a CISC microprocessor, a Microcontroller Unit (MCU), a CISC-based Central Processing Unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function. The hardware of such devices may be integrated onto a single substrate (e.g., silicon “die”) or distributed among two or more substrates. Various functional aspects of the processor 602 may be implemented solely as software or firmware associated with the processor 602.

Memory 604 may include random access memory (RAM), read-only memory (ROM), and/or another type of dynamic or static storage device (e.g., flash memory, magnetic memory, optical memory, etc.) that stores information and/or software instructions for use by the processor 602. Other examples of memory 604 can include flash memory, Random Access Memory (RAM), Read Only Memory (ROM), Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The examples provided herein can include a computer-readable medium and/or storage component (e.g., a non-transitory computer-readable medium), which. is defined herein as a non-transitory memory device. A non-transitory memory device includes memory space located inside of a single physical storage device or memory space spread across multiple physical storage devices.

Software instructions may be read into memory 604 from another computer-readable medium or from another device via a communication interface with computing device. When executed, software instructions stored in memory may cause the processor to perform one or more processes described herein. Embodiments described herein are not limited to any specific combination of hardware circuitry and software.

The processor 602 can include one or more processing or operating modules, such as an operating system and computer programs (e.g., computer control logic). A processing or operating module can be a software or firmware operating module configured to implement any of the functions disclosed herein. The processing or operating module can be embodied as software and stored in memory 604. The memory 604 being operatively associated with and communicably coupled to the processor 602. A processing module can be embodied as a web application, a desktop application, a console application, or other suitable application as desired.

The term “computer-readable medium” (or “machine-readable medium”) as used herein is an extensible term that refers to any medium or any memory, which participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine-readable medium can be configured to store one or more instructions thereon. The instructions can be in the form of algorithms, program logic, etc. that cause the processor to execute any of the functions disclosed herein.

Embodiments of the memory 604 can include a processor module and other circuitry to allow for the transfer of data to and from the memory, which can include to and from other components of a communication system. This transfer can be via hardwired or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

In an exemplary embodiment, the data can be configured in any type of suitable database configuration, such as a relational database, a structured query language (SQL) database, a distributed database, an object database, etc. According to an exemplary embodiment, the data can be stored on one or more device configured to operate as cloud storage on a network. Suitable configurations and storage types will be apparent to persons having skill in the relevant art.

The exemplary computing device 600 can also include a communications interface 606. The communications interface 606 can be configured to allow software and data to be transferred between the computing device and external devices. Exemplary communications interfaces 606 can include a modem, a network interface (e.g., an Ethernet card), a communications port, a PCMCIA slot and card, etc. Software and data transferred via the communications interface 606 can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

According to exemplary embodiments described herein, the combination of the memory 604 and the processor 602 can store and/or execute computer program code for performing the specialized functions described herein. For example, via any known or suitable service or platform, the program code can be deployed (e.g., streamed and/or downloaded) remotely from computing devices located on a local-area or wide-area network and/or in a cloud-computing arrangement or environment.

The computing system 600 or device may also include a receiver or receiving device 608, an input/output (I/O) interface 610, a transmitting device 612, a communication infrastructure 614, an input device 616, a communication network 618, and a database 620 and/or cloud storage 624.

The receiver or receiving device 608 may be a combination of hardware and software components configured to receive data samples from the mobile network or database. According to exemplary embodiments, the receiving device 608 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. The receiving device 608 can be an input device for receiving signals and/or data samples formatted according to 3GPP protocols and/or standards. The receiving device 608 can be connected to other devices via a wired or wireless network or via a wired or wireless direct link or peer-to-peer connection without an intermediate device or access point. The hardware and software components of the receiving device 608 can be configured to receive the data from the mobile network according to one or more communication protocols and data formats. For example, the receiving device 608 can be configured to communicate over a network 620, which may include a local area network (LAN), a wide area network (WAN), a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, the receiving device 608 can be configured to identify parts of the received data via a header and parse the data signal and/or data packet into small frames (e.g., bytes, words) or segments for further processing at the processor.

The I/O interface 610 can be configured to receive the signal from the processor and generate an output suitable for a peripheral device via a direct wired or wireless link. The I/O interface 610 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

The transmitting device 612 can be configured to receive data from the processor and assemble the data into a data signal and/or one or more data packets according to the specified communication protocol and data format of a peripheral device or remote device to which the data is to be sent. The transmitting device 612 can include one or more hardware and software components for generating and communicating the data signal over the communications infrastructure and/or via a direct wired or wireless link to a peripheral or remote device. The transmitting device 612 can be configured to transmit information according to one or more communication protocols and data formats as discussed in connection with the receiving device.

The input device 616 is configured to receive an input from a user for processing and/or use by the CPU 602. For example, the input device 618 can be implemented as a physical or virtual keyboard, a physical or virtual touchpad, a microphone, or any suitable device for inputting data or information as desired. The input device 616 can be configured to format the received user input suitable for use by the CPU 602 or be configured to provide the user input to the I/O interface 610 for further processing. According to an exemplary embodiment, the input device 616 can be configured to communicate wirelessly with the computing system 600 or be integrated into the housing of the computing system 600 or have a physical connection to the computing device 600. In performing the described operations, the input device 616 can be configured to include a combination of hardware and software components.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processors (e.g., by a compiling module or engine) prior to execution. For example, the program code may be source code written in a programming language that is translated into a lower-level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling the system to perform the functions disclosed herein. It will be apparent to persons having skill in the relevant art that such processes result in the system being a specially configured computing device uniquely programmed to perform the functions of the exemplary embodiments described herein.

It will be appreciated by those skilled in the art that the present disclosure can be embodied in other specific forms without departing from the spirit or essential characteristics thereof. The presently disclosed embodiments are therefore considered in all respects to be illustrative and not restrictive. The scope of the disclosure is indicated by the appended claims rather than the foregoing description, and all changes that come within the meaning, range, and equivalence thereof are intended to be embraced therein.

What is claimed is:

1. A method for generating a virtual training exercise on a physical platform, the method comprising:
generating, by a camera of the physical platform, a live video feed from a point of view of the physical platform in a training location;
detecting, by a computing system of the physical platform, one or more live assets in the live video feed;
injecting, by the computing system of the physical platform, synthetic data for each of the one or more detected live assets into the live video feed;
generating, by the computing device of the physical platform, synthesized data by combining an operator interface associated with the physical platform and the live video feed including the one or more detected live assets and the synthetic data for each of the one or more detected live assets, wherein the operator interface is overlayed onto the live video feed and the synthetic data for each of the one or more detected live assets is controlled to move in a specified alignment relative to the one or more detected live assets; and
generating, by a display device of the physical platform, a graphical interface for displaying the synthesized data.

2. The method of claim 1, further comprising:
extracting, by the computing device, one or more features of the one or more detected live assets in the live video feed;
comparing, by the computing device, the one or more features of the one or more detected live assets to a database of features associated with known live assets; and
identifying, by the computing device, the one or more detected live assets in the live video feed based on a comparison result.

3. The method of claim 2, further comprising:
searching, by the computing device, one or more databases for the synthetic data based on the one or more identified live asset and one or more search parameters; and
extracting, by the computing device, a three-dimensional (3D) model that matches the one or more search parameters from the one or more databases.

4. The method of claim 3, wherein the 3D model is an object that matches the identified live asset.

5. The method of claim 2, further comprising:
transmitting, by the computing device, the one or more identified live assets to a central server for sending the one or more identified live assets to one or more other physical platforms in the training location.

6. The method of claim 1, further comprising:
generating data for localizing the one or more live assets in the training location.

7. The method of claim 6, further comprising:
estimating, by the computing device, a distance from the camera system to a point on the one or more detected live assets;
generating, by the computing device, first distance information including at least the estimated distance; and
sending, by the computing device, the first distance information to a central server for access by one or more other physical platforms in the training location.

8. The method of claim 7, further comprising:
receiving, by the computing device, at least second distance information from another physical platform having a different point of view in the training location, the second distance information including location data of the detected object from the different point of view in the training location; and
localizing, by the computing device, the detected object relative to the physical area using the first distance information and the second distance information.

9. A system for generating a virtual training exercise on a physical platform, the system comprising:
a camera system mounted to the physical platform, wherein the camera system is configured to generate a live video feed from a point of view of the physical platform in a training location; and
a computing system of the physical platform, the computing system being configured to:
detect at least one live asset in the live video feed;
inject synthetic data for each of the detected at least one live asset into the live video feed; and
generate synthesized data by combining an operator interface associated with the physical platform, the live video feed including the at least one detected live asset and the synthetic data for each of the at least one detected live asset, wherein the operator interface is overlayed onto the live video feed and the synthetic data for each of the at least one detected live asset is controlled to move in a specified alignment relative to the at least one detected live asset; and
a display device configured to generate a graphical interface for displaying the synthesized data.

10. The system of claim 9, wherein the computing device is further configured to:
extract one or more features of the at least one detected live asset in the live video feed;
compare the one or more features of the at least one detected live asset to a database of features associated with known live assets; and
identify the at least one detected live asset in the live video feed based on a comparison result.

11. The system of claim 10, wherein the computing device is further configured to:
search one or more databases for the synthetic data based on the at least one identified live asset and one or more search parameters; and
extract a three-dimensional (3D) model that matches the one or more search parameters from the one or more databases.

12. The system of claim 11, wherein the 3D model is an object that matches the at least one identified live asset.

13. The system of claim 10, wherein the computing device is further configured to:
transmit the identified live asset to a central server for sending the at least one identified live asset to one or more other physical platforms in the training location.

14. The system of claim 9, wherein the computing device is configured to:
generate data for localizing the at least one live asset in the training location.

15. The system of claim 14, wherein the computing device is configured to:
estimate a distance from the camera system to a point on the at least one detected live asset;
generate first distance information for the at least one detected live asset, the first distance information including at least the estimated distance; and
send the first distance information to a server for access by one or more other physical platforms in the training location.

16. The system of claim 15, wherein the computing device is configured to:
receive at least second distance information from another physical platform having a different point of view in the training location, the second distance information including location data of the at least one detected live asset from the different point of view in the training location; and
localize the at least one detected live asset in the training location using the first distance information and the second distance information.

17. A non-transitory computer-readable medium storing programming code for generating a virtual training exercise on a physical platform, which when placed in communicable contact with one or more processors of a physical platform, the computer-readable medium, via the programming code, causing the physical platform to be configured to perform operations comprising:
generating, by a camera of the physical platform, a live video feed from a point of view of the physical platform in a training location;
detecting, by a computing system of the physical platform, one or more live assets in the live video feed;
injecting, by the computing system of the physical platform, synthetic data for each of the one or more detected live assets into the live video feed;
generating, by the computing device of the physical platform, synthesized data by combining an operator interface associated with the physical platform and the live video feed including the one or more detected live assets and the synthetic data for each of the one or more detected live assets, wherein the operator interface is overlayed onto the live video feed and the synthetic data for each of the one or more detected live assets is controlled to move in a specified alignment relative to the one or more detected live assets; and
generating, by a display device of the physical platform, a graphical interface for displaying the synthesized data.
